(19) United States
(12) Patent Application Publication
(10) Pub. No.: US 2005/0111215 A1
(43) Pub. Date: May 26, 2005

(54) Electronic device

(76) Inventor: Yung-Ho Lee, San Chung City (TW)

Correspondence Address: TROXELL LAW OFFICE PLLC, Suite 1404, 5205 Leesburg Pike, Falls Church, VA, 22041, US

(21) Appl. No.: 10/717,491

(22) Filed: Nov. 21, 2003

(51) Int. Cl. F21S 8/00

(52) U.S. Cl. 362/148

(57) ABSTRACT

The present invention generally relates to an improved electronic device, which comprises a case having a containing room, a container for reserving electronic device and embedded in the containing room for electrical engagement, an electrical structure being an interface between the case and the container. Therefore, in the needs of changing power-supply components or power-consumption components are simply to dismantle the container, and the components can then be changed very easily.

### BACKGROUND OF THE INVENTION

1. Field of the Invention

The present invention generally relates to an improved electronic device, in which an independent container embedded in the casing or attached to the shielding can be dismantled easily. Therefore, consumers can easily replace the power-supply components or power-consumption components on the container.

2. Description of the Prior Art

Due to the technology advance, many product on the market today tend towards DIY(Do-It-Yourself), especially consumed goods. For example, when the battery of the electronic decoration on the car window runs out, user has to replace the battery in order for it to function properly. The electronic decoration is often glued to the windshield inside the car, which can't be dismantled as a whole. Therefore, one must open the battery casing in order to replace the batteries, which sometime is not a pleasant thing to do. Because the batteries might pop out or fall off of the battery casing if one is not careful, which is inconvenient for consumers.

Further, take housing detector or fluorescent lamp as an example. When users need to replace the battery in the housing detector or a fluorescent lamp. One must raise its head, in an abnormal position, which causes aching around the neck. Pain can cause distraction and lead to accidents. Fluorescent lamp is fragile and must treat with extreme care.

Accordingly, another example is the battery container of a gas-operated hot-water heater. When the battery of the gas-operated hot-water heater runs out, the ignition will not take place. Users need to replace the battery in the gas-operated hot-water heater, the batteries might pop out or fall off of the battery casing if one is not careful.

### SUMMARY OF THE INVENTION

The main objective of the present invention is to offer means of replacing power-supply components or power-consumption components for the convenience of consumer. Firms therefore developed an independent electronic container for reserving electrical device and embedded in the containing room. Therefore, in the needs of changing power-supply components or power-consumption components are simply to dismantle the container, and the power-supply components or power-consumption components can then be changed very easily. Reducing the chance of abnormal position or pain around the neck and accidents.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a sketch of the present invention;

FIG. 2 is the first preferred embodiment of FIG. 1;

FIG. 3 is the second preferred embodiment of FIG. 1;

FIG. 4 is the fourth preferred embodiment of the present invention;

FIG. 5 is an application of the preferred embodiment in FIG. 4;

FIG. 6 is the fifth preferred embodiment of the present invention;

FIG. 7 is another preferred embodiment of FIG. 6;

FIG. 8 is the seventh preferred embodiment of the present invention;

FIG. 9 is the eighth preferred embodiment of the present invention;

FIG. 10 is a 3-D sketch of the shielding in FIG. 9;

FIG. 11 is another preferred embodiment of FIG. 9;

### DETAILED DESCRIPTION OF THE INVENTION

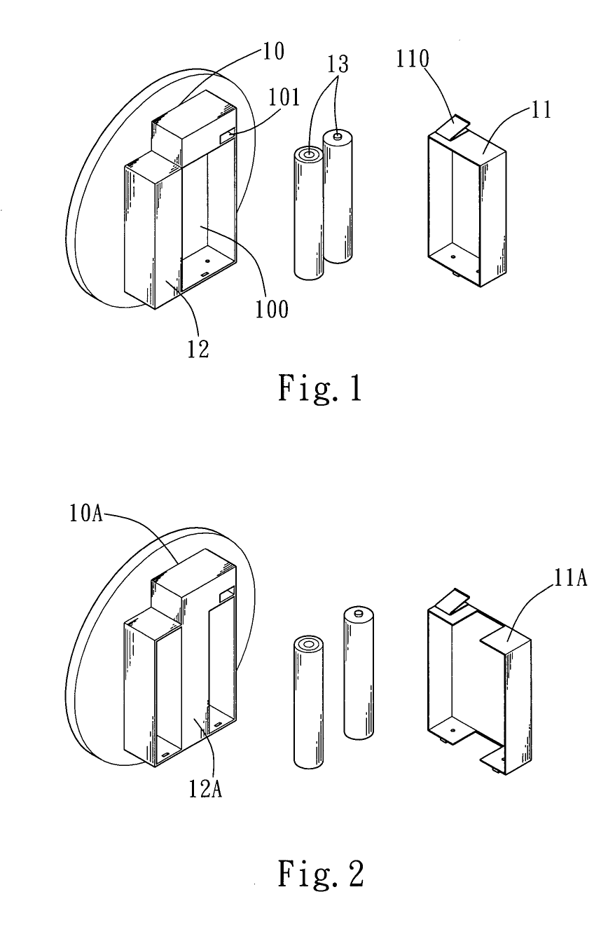

Referring to FIG. 1, which is a sketch of the present invention. As we can see the present invention comprising a case 10, a containing room 100, a slot 101; a container 11, which is independent from the electronic device for reserving electronic device and embedded in the containing room of the case for electrical engagement. A fastener 110 is allocated on the container 11, when the container 11 is embedded in the containing room 100, the fastener 110 is placed in the slot 101 to secure the container 11 to the case 10; An electrical structure 12, which can be a combination of capacitors, adaptors, and wires, being an interface between the case 10 and the container 11 for supplying power; a power-supply component 13, which can be a battery, is allocated on the container 11 supplying the power for the electronic device.

Referring to FIG. 2, which is the first preferred embodiment of FIG. 1. The difference between FIG. 1 and FIG. 2 is the electrical structure 12A, which is allocated on the case 10A is different, at the same time, the container 11A will change its appearance accordingly to fit with the case 10A.

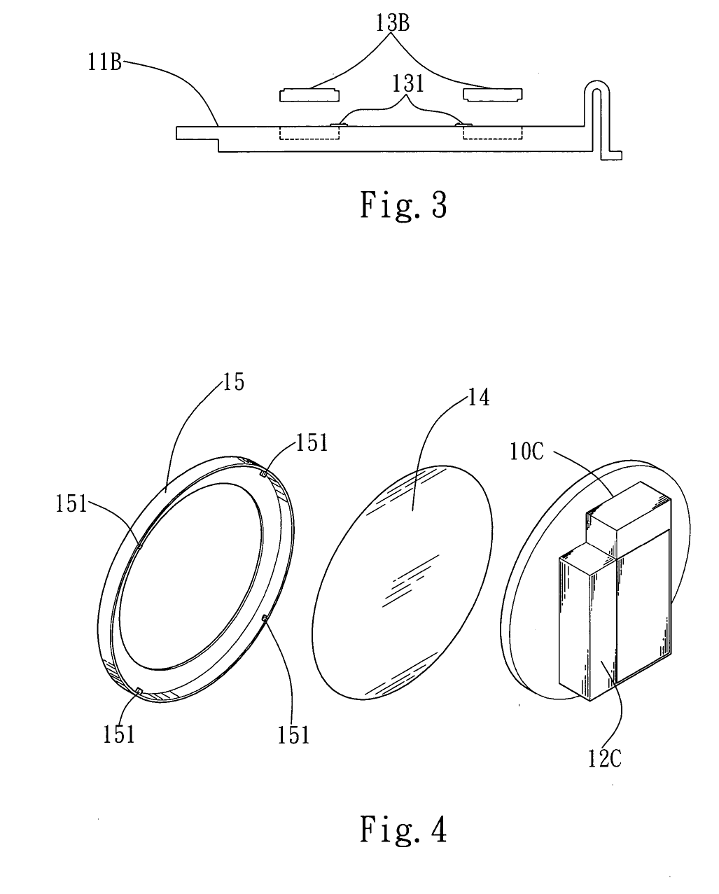

Referring to FIG. 3, which is the second preferred embodiment of FIG. 1. The difference between FIG. 1 and FIG. 3 is appearance of the power-supply component 13. The power-supply component 13 in FIG. 1 is cylindrical and the power-supply component 13B in FIG. 3 is oblate. The container 11B can be designed to fit with the power-supply component 13B, and a fastener 131 is located on the container 11B to prevent the power-supply component 13B from falling out. The appearance of power-supply component 13B of the present invention is not limited thereto, the power-supply component 13B could be in a rectangular form (not shown).

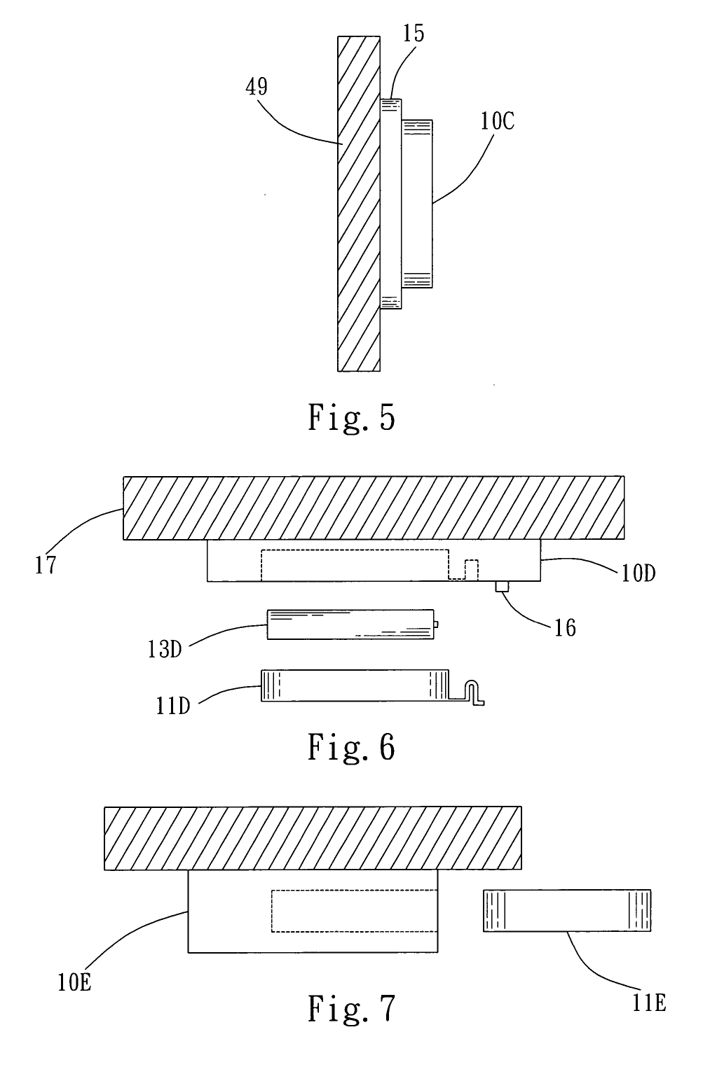

Referring to FIG. 4, which is the fourth preferred embodiment of the present invention. The embodiment shown in FIG. 4 contains a electro-luminescent 14, which is electrically conducted with the electrical structure 12C. The case 10C is attached with a shielding 15, which is hollow in the middle. The electro-luminescent 14 is placed between the case 10C and a shielding 15. The shielding 15 has a plurality of bumps 151 on one side of the shielding 15. The function of the bumps 151 is to prevent the case 10C from falling off. Thus, the shielding 15 can rotate around a fixed-axis when glued to a glass 49 (as shown in FIG. 5). The consumer replacing the power-supply component 13 or the oblate power-supply component 13B will be easier due to the capability to rotate and to adjust. The appearance of the electro-luminescent 14 and the shielding 15 of the present invention is not limited thereto, the shielding 15 could be designed in polyhedral (not shown) and the electro-luminescent 14 can be replaced by a LED (not shown) for customer's appeal.

Referring to FIG. 6, which is the fifth preferred embodiment of the present invention. The preferred embodiment shown in FIG. 6 is used for detectors, which comprising of a case 10D, a container 11D, and a power-supply component 13D. Home detectors are usually located on a ceiling 17, therefore using the power-supply component 13D in the present invention will be easier for replacement, and the batteries will not pop out or fall off nor will accidents likely to take place. Reducing the chance one must raise its head, in an abnormal position, which causes aching around the neck, which the pain can cause distraction and lead to accidents. Further, a LED 16 can be allocated on the electronic device, which the LED 16 acts as a power indicator signaling the power left in the power-supply component 13D.

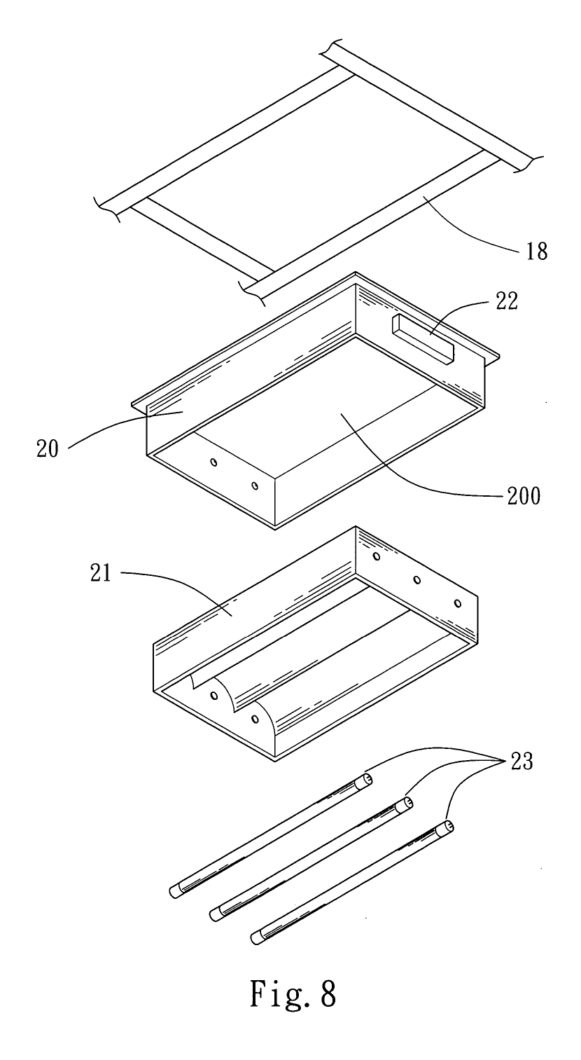

Referring to FIG. 7, which is another preferred embodiment of FIG. 6. The difference between FIG. 6 and FIG. 7 is the container 11E is embedded from the side of the case 10E. The design was to prevent the container 11E to fall off for not being fastened.

Referring to FIG. 8, which is the seventh preferred embodiment of the present invention. The present invention comprising of a case 20, which is located on the frame 18 of the ceiling having a containing room 200 in the case 20; a container 21 which is independent from the electronic device for reserving electronic device and embedded in the containing room 200 of the case 20 for electrical engagement; an electrical structure 22, which can be a combination of capacitors, resistors, and adaptors, being an interface between the case 20 and the container 21 for delivering power; three power-consumption components 23, e.g. fluorescent lamps. The power-consumption components 23 are located in the container 21. Thus, when the power-consumption components 23 needs replacing, just simply dismantle the container 21 from the case 20 and one can replace the power-consumption components 23 in comfortable ways, then the container 21 installed in the containing room 200 of the case 20.

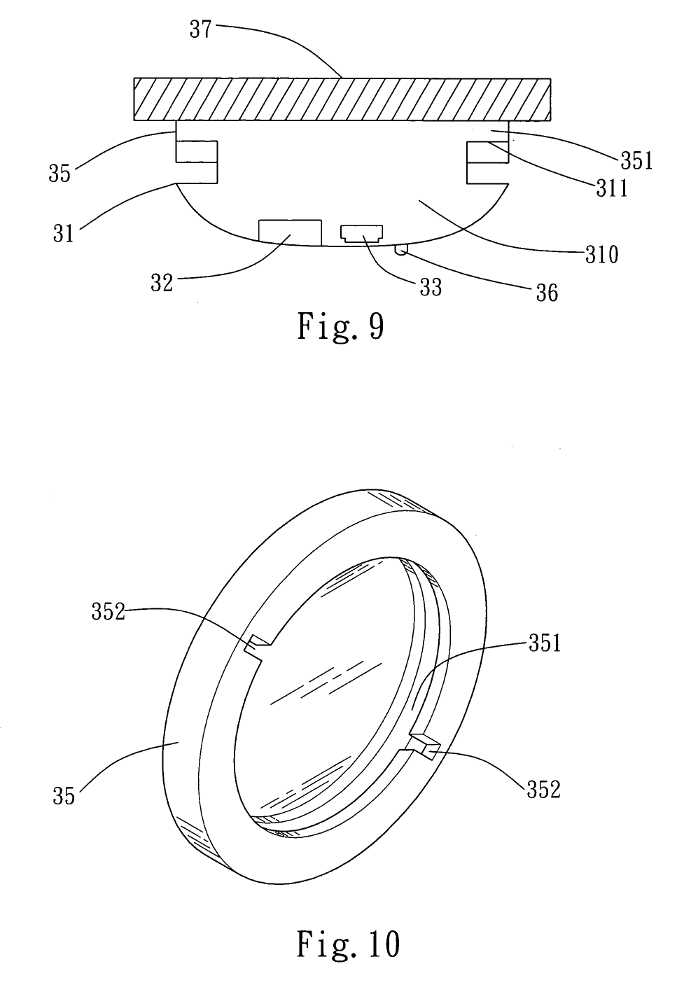

Referring to FIG. 9 which is the eighth preferred embodiment of the present invention comprising of: a shielding 35 which is fixed to ceiling 37 and there is a slot 351 located within the shielding 35; a container 31 having a containing room 310, two ledges 311 is further located on the container 31 can interlock with the slot 351; an electrical structure 32, which can be a combination of capacitors, resistors, and adaptors, being an interface for conducting electrically; a power-supply component 33, is allocated in the containing room 310 of the container 31 and electrically conducted to the electrical structure 32 for supplying power; a LED 36 which is electrically conducted to the electrical structure 32 for displaying the power of the battery.

Referring to FIG. 10, which is a 3-D sketch of the shielding in FIG. 9. We can clearly see that the slot 351 of the shielding 35 has two holes 352, and the hole 352 fit with ledge 311 in order to circle inside slot 351 to interlock with each other. The shielding 35 and the container 31 of the present invention is not limited thereto, for example, the shielding 35 and the container 31 could be designed in spiral-shaped.

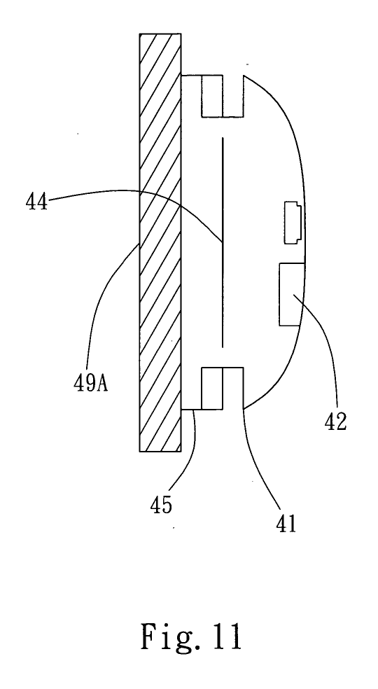

Referring to FIG. 11, which is the another preferred embodiment of FIG. 9. The difference between FIG. 11 and FIG. 9 is that the present invention is glued to a glass 49A and the present invention further includes a electro-luminescent 44 is placed between the container 41 and a shielding 45 which is hollow in the middle. The electro-luminescent 44 is electrically conducted to the electrical structure 42 and the light of the electro-luminescent 44 can pass through the glass 49A to the outside. The electro-luminescent 44 can be replaced by a LED (not shown) for customer's appeal.

The characteristic of the present invention concludes as follows:
1. The container can easily dismantled from the shielding or the case without any needs for abnormal position which might cause injuries. Replacing parts are made easier since the power-supply component or the power-consumption component are located in the container, which is very easy to install or dismantle and doesn't require a lot of time replacing parts.
2. Prevent the power-supply component or the power-consumption component might pop out or fall off of the case if one is not careful, therefore causing accidents.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. An improved electronic device, which comprising of:
a case having a containing room;
a container independent from the electronic device for reserving electronic device and embedded in the containing room of the case for electrical engagement;
an electrical structure being an interface between the case and the container for supplying power.

2. The improved electronic device as claimed in claim 1, the case has a slot.

3. The improved electronic device as claimed in claim 2, the container allocated a fastener, when embedded in the containing room, the fastener fastened onto the embedded slot to secure the container.

4. The improved electronic device as claimed in claim 1, the container allocated at least one power-supply component.

5. The improved electronic device as claimed in claim 4, the power-supply component is a battery.

6. The improved electronic device as claimed in claim 1, the container allocated at least one power-consumption component.

7. The improved electronic device as claimed in claim 6, the power-consumption component is a fluorescent lamp.

8. The improved electronic device as claimed in claim 1, the electronic device allocated at least one lighting component.

9. The improved electronic device as claimed in claim 8, the lighting component is a electro-luminescent.

10. The improved electronic device as claimed in claim 8, the lighting component is a LED.

11. An improved electronic device, which comprising of:
a shielding;
a container has a containing room for reserving electrical device and incorporate with the shielding;
an electrical structure allocated in the containing room of the container for supplying power.

12. The improved electronic device as claimed in claim 11, the electronic device container allocated at least one power-supply component.

13. The improved electronic device as claimed in claim 12, the power-supply component is a battery.

14. The improved electronic device as claimed in claim 11, the electronic device allocated at least one lighting component.

15. The improved electronic device as claimed in claim 14, the lighting component is a electro-luminescent.

16. The improved electronic device as claimed in claim 14, the lighting component is a LED.

17. The improved electronic device as claimed in claim 11, the shielding and the container incorporated by fasten means.

18. The improved electronic device as claimed in claim 11, the shielding and the container incorporated by screw means.
